(19) United States
(12) Patent Application Publication
(10) Pub. No.: US 2024/0109470 A1
(43) Pub. Date: Apr. 4, 2024

(54) Platform Loading Device

(71) Applicant: Nikolas Beisert, Penn Valley, CA (US)

(72) Inventor: Nikolas Beisert, Penn Valley, CA (US)

(21) Appl. No.: 17/956,297

(22) Filed: Sep. 29, 2022

(51) Int. Cl. B60P 1/14; B60P 1/44; B60P 1/52

(52) U.S. Cl. CPC B60P 1/14; B60P 1/4407; B60P 1/52

(57) ABSTRACT

A winch activated loaded platform is described to enable single person loading and unloading of heavy objects into a cargo carrying vehicle, like a pickup truck. The device is installed in the vehicle and loads a platform into the vehicle with a singular electric winch, without the use of hydraulics, booms, or ramps. A novel sheet metal and ball bearing receiver aligns and transitions the platform from vertical to horizontal loading into the vehicle with a singular winch and winch cable. V-groove ball bearing wheels on the base and steel angle track on the platform reduce friction for loading and unloading of the platform. A system of horizontal and vertical latches keep the platform secure during transport. Cargo is secured with tie down points for large cargo such as motorcycles and sidewall mounts for loose materials and fragmented cargo. A removable and stowable frame section preserves functionality of a pickup truck tailgate.

### BACKGROUND

This invention relates to loading devices, and more particularly to winch-driven loading devices for utility vehicles such as pick up trucks, flat beds, trailers, vans, and the like.

Pickup trucks and utility vehicles are designed to carry loads too heavy for individual loading without assistance. Many configurations of loading devices have been developed to assist with loading, though these devices are excessively complex, heavy, and expensive.

Means for loading with electric winches are known. U.S. Pat. No. 8,534,978 to Dieziger, for example, discloses a system with multiple winches and a microprocessor for loading and unloading. A singular electric winch has sufficient torque to load heavy objects onto a utility vehicle without the use of additional winches, hydraulic systems, rails, or ramps.

The invention provides the means by which a singular winch can load a platform into a utility vehicle. The novel approach is distinguished by an alignment and transition mechanism with a singular winch cable, and the absence of additional cables, booms, hydraulics, rails, and ramps.

### SUMMARY

It is an object of the present invention to provide a simple, safe, and low-cost method of loading different types and varieties of heavy cargo and objects into a pickup truck or other utility vehicle.

It is further an object of the present invention to utilize a singular winch as the motive power to lift and load cargo and objects into a pickup truck or other utility vehicle.

It is further an object of the present invention to align and transition a loading platform into a pickup truck or other utility vehicle with a singular winch cable, without hydraulics, booms, rails, or ramps.

It is further an object of the present invention to maintain alignment and control of the loading platform throughout the loading process into a pickup truck or other utility vehicle.

It is further an object of the present invention to secure the platform once loaded onto the pickup truck or other utility vehicle such that it does not move during transport.

It is further an object of the present invention to enable simple, controlled unloading of the platform out of the pickup truck or other utility vehicle.

It is further an object of the present invention to avoid permanent installation of loading equipment into the pickup truck or utility vehicle, to avoid reducing its utility.

It is further an object of the present invention to be stowable when installed in a pickup truck to preserve utility of the pickup truck tailgate when the platform is not in use.

These objects are embodied in a system for loading heavy objects into a vehicle, in this case, a pickup truck, comprising a frame assembly designed to conform to the space available in the bed of the pickup truck, a platform that is loaded onto the frame from the ground, a winch that attaches to the front of the frame, and a novel system of ball-bearing rollers on the frame and loading adapter on the platform that enable the winch to singularly load the platform onto the frame.

### BRIEF DESCRIPTION OF THE FIGURES

FIG. 1 is a view of the platform loading device in accordance with the invention showing the platform loading sequence from fully unloaded to fully loaded into a utility truck.

FIG. 2 is a view of the platform loading device in accordance with the invention showing the platform and base structure with the stowable components to preserve functionality of a pickup truck tailgate.

FIG. 3 is a view of the platform component of the invention indicating the components of the platform that enable the platform to be loaded and secured during transport.

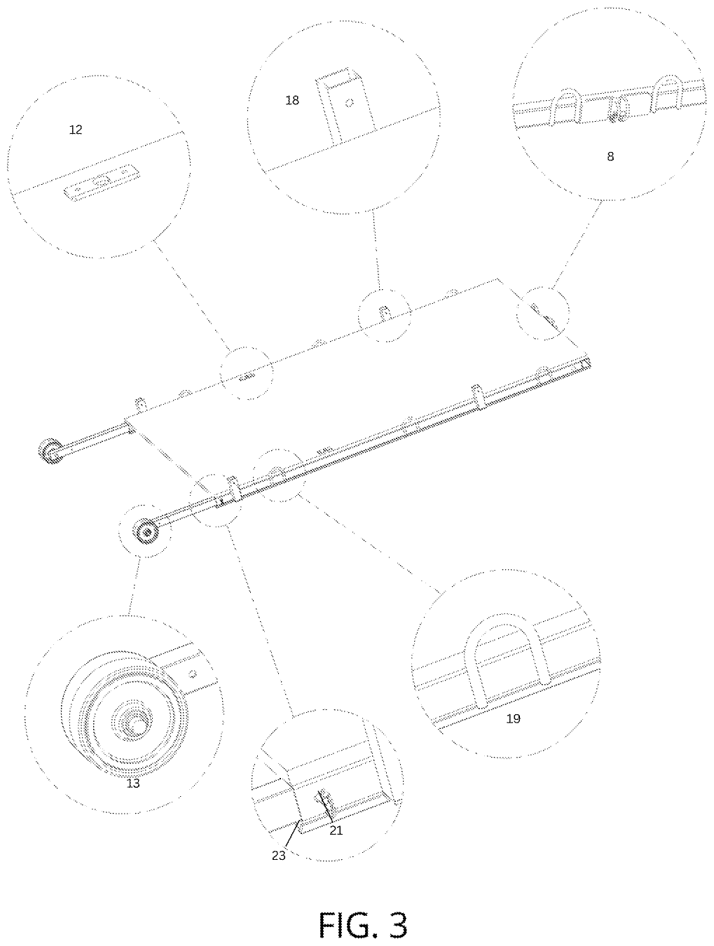

FIG. 4 is a view of the base component of the invention indicating the components of the base that enable the platform to be loaded and secured during transport.

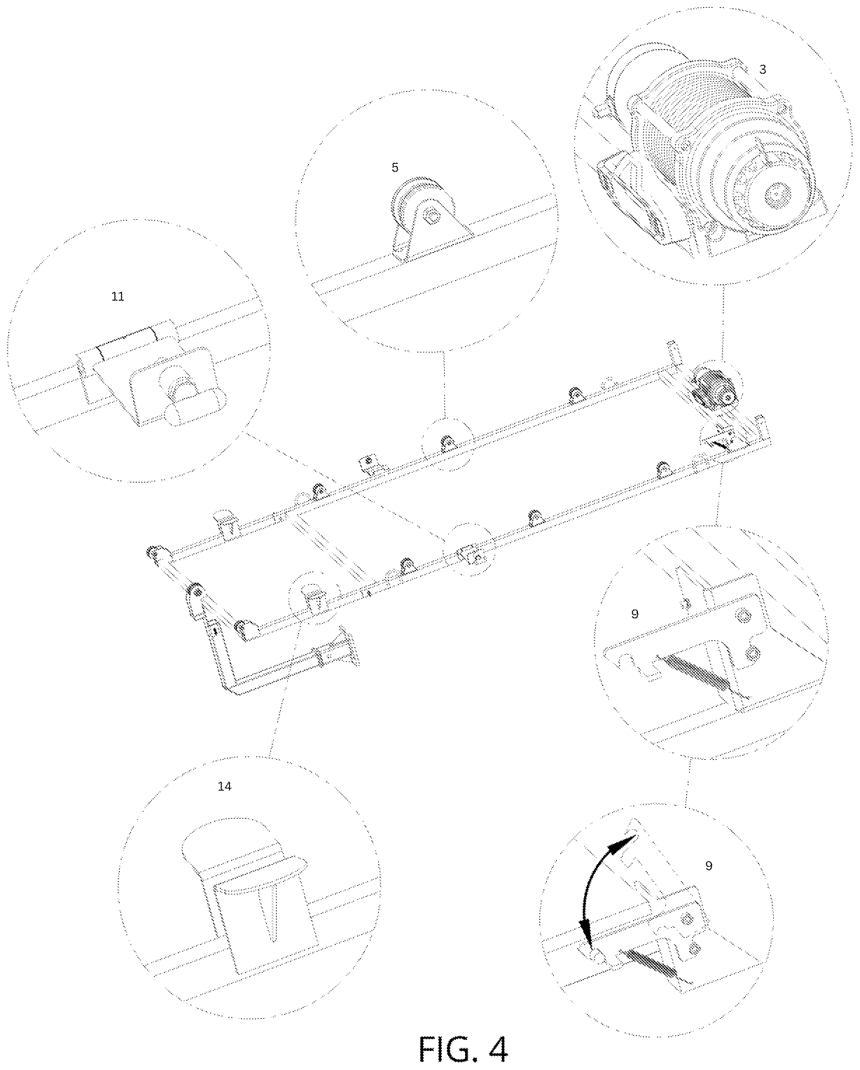

FIG. 5 is a view of the underside of the platform loading device in accordance with the invention.

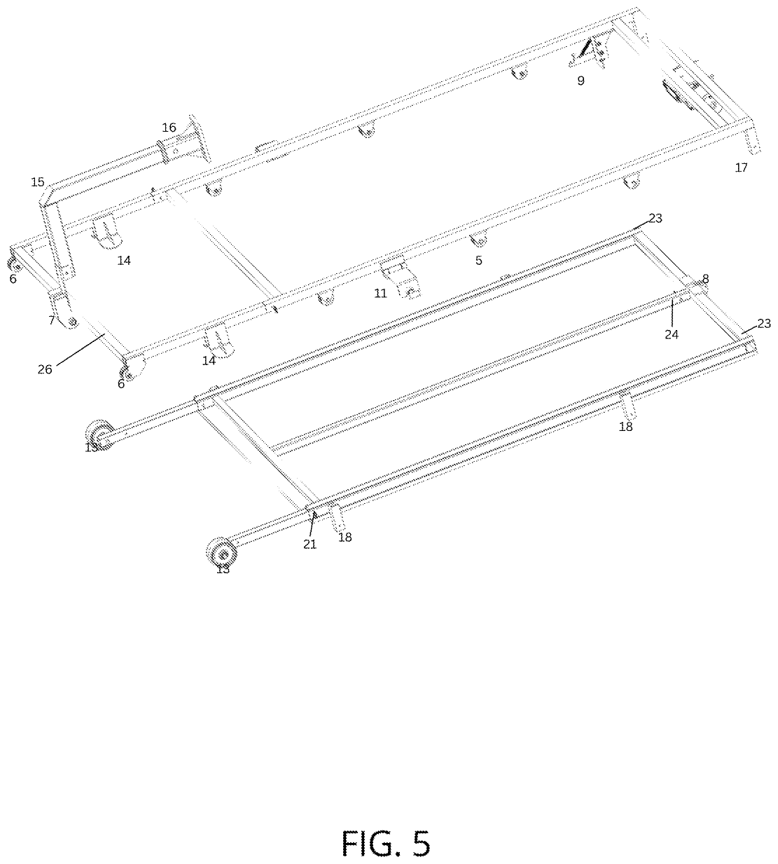

FIG. 6 is a view of the winch cable path and attachment point to the platform in accordance with the invention.

FIG. 7 is a side view of the loading path of the platform to the frame and winch cable routing in accordance with the invention.

FIG. 8 is a view of a platform alignment accessory in accordance with the invention.

FIG. 9 is a view of the removable tailgate element in a stowed position in accordance with the invention.

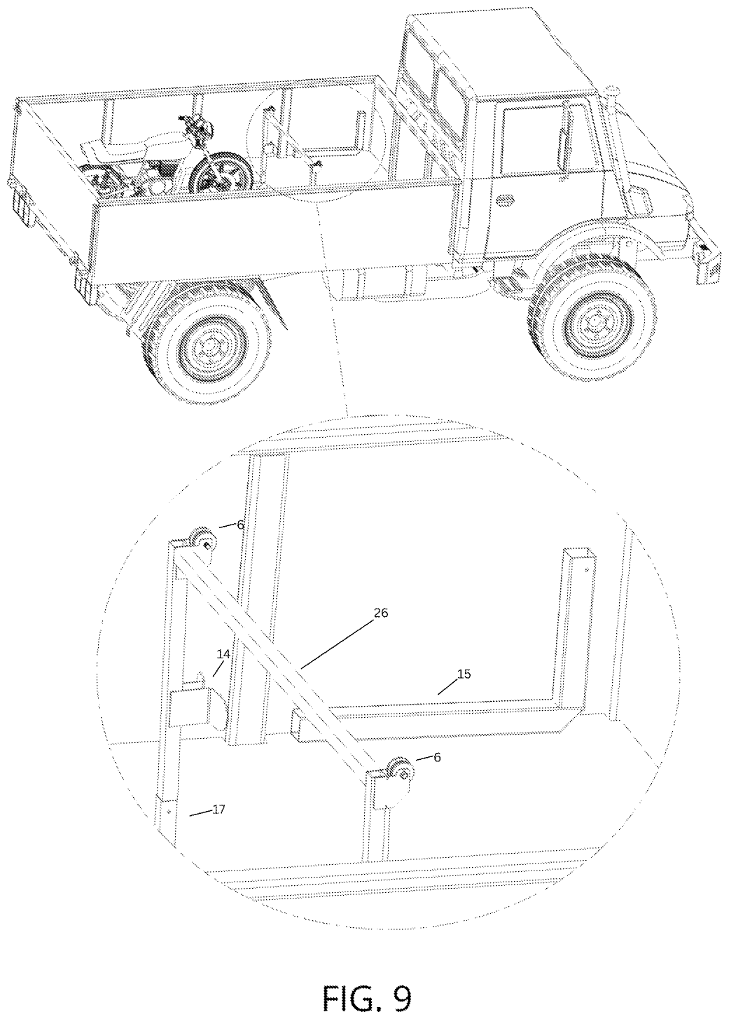

### DETAILED DESCRIPTION OF CERTAIN EMBODIMENTS

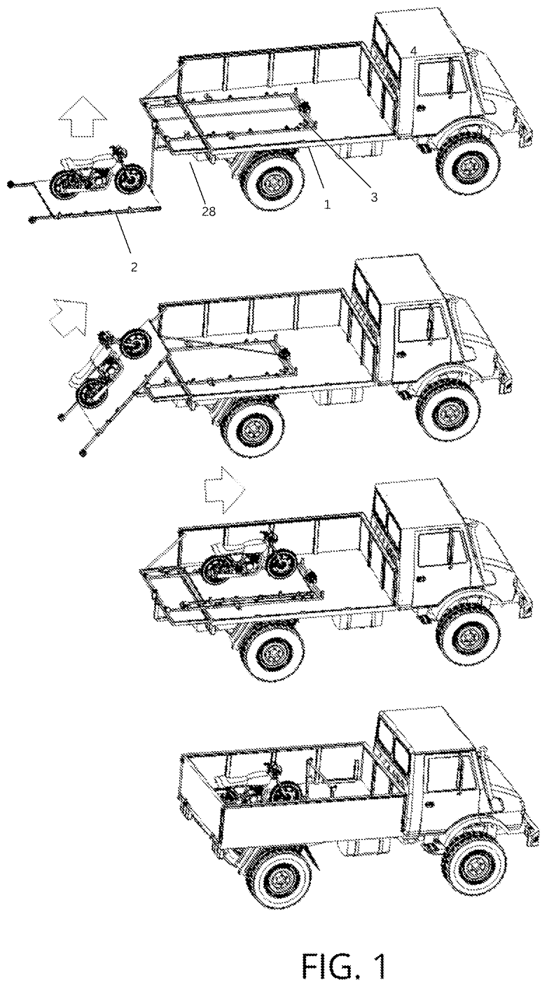

By way of example, one embodiment of the platform loading device is configured to enable single person loading of heavy objects into a utility truck. Referring to FIG. 1, the principle components of the loading platform are the base 1, the platform 2, and the winch 3. The base 1 is attached to the utility truck 4, the winch 3 is attached to the base 1, the winch cable is attached to the platform 2, and the winch 3 raises and draws the platform 2 onto the base 1.

The base assembly 1 has a removable section 26 to preserve truck tailgate 28 function when the platform is not loading or unloading. Removable section 26 is secured with removable pin 22 and stowed on mounting tubes 17. Removable section 26 is supported by a hitch reinforcement 15 that attaches to the vehicle hitch adapter 16 to reduce loading stress on tailgate 28.

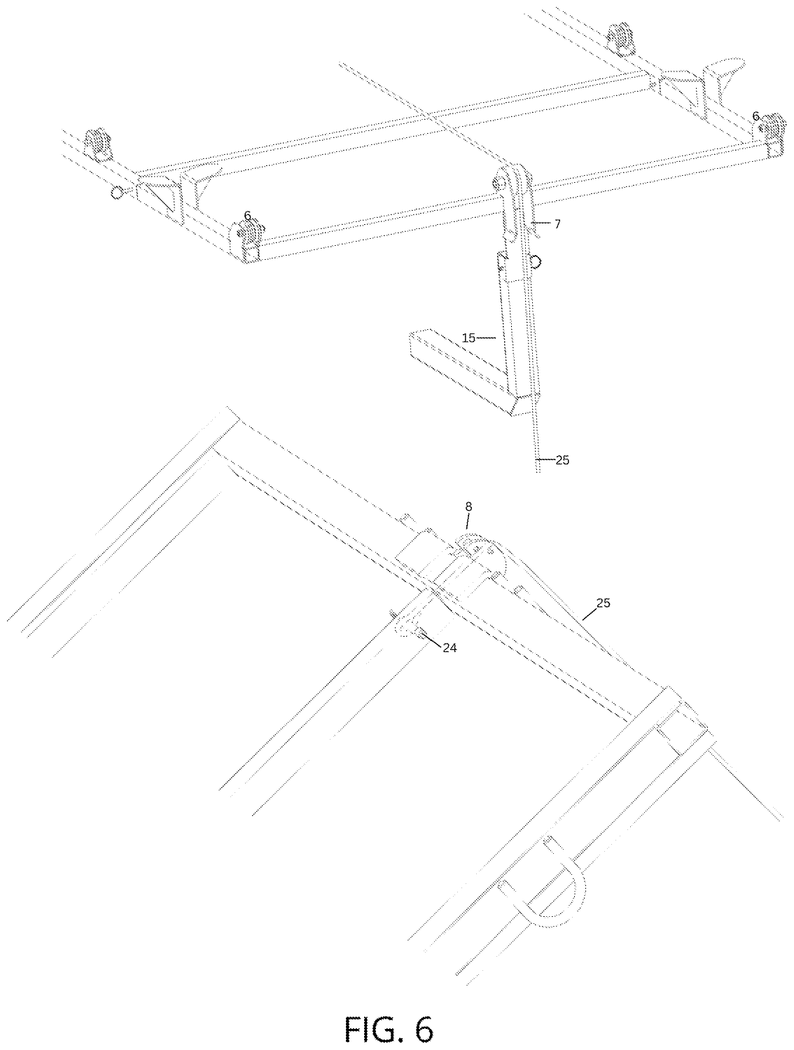

The routing of the winch cable 25 is best seen in FIG. 6, the winch cable 25 extends from winch 3, over the roller 7 mounted to the base 1 into the adapter 8 mounted to the platform 2, and pinned internally to the center platform 2 tube with removable pin 24. The platform 2 separates from the frame 1 and winch 3 when winch cable 25 is disconnected from pin 24.

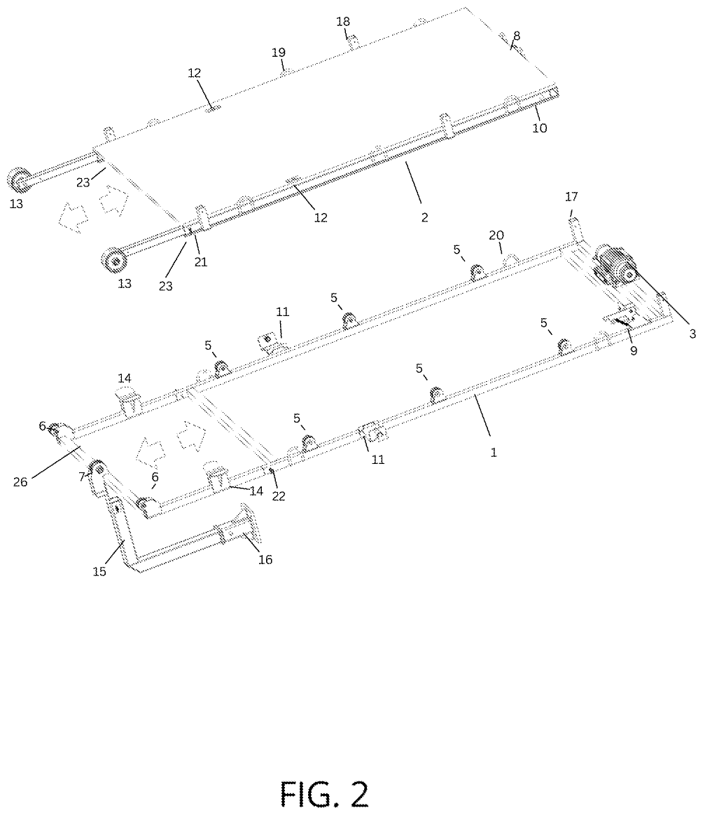

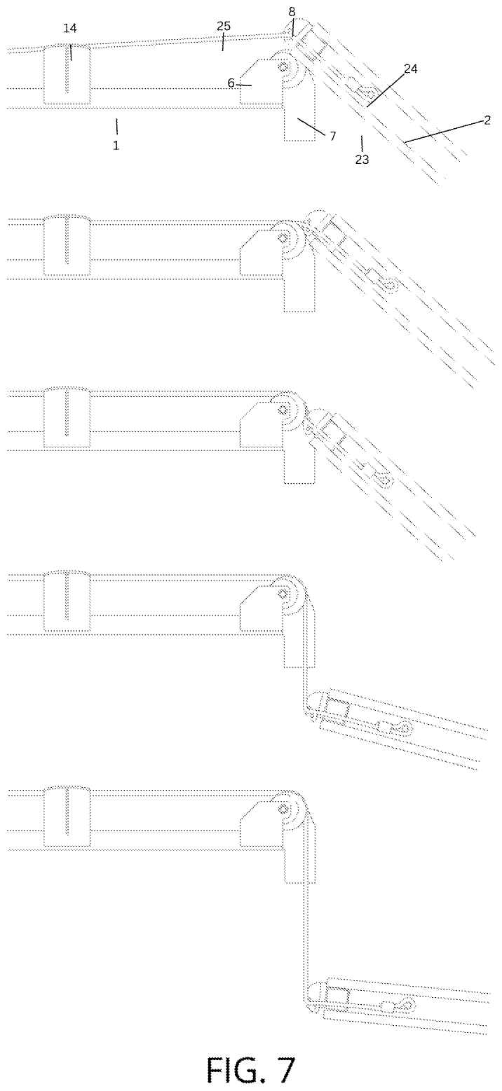

Referring to FIG. 7, the platform 2 loads onto the base 1 initially by the vertical force of the winch cable 25 over the roller 7 pulling vertically upwards on platform 2 through adapter 8 and pin 24. As the platform 2 approaches roller 7, the roller 7 side plates center the platform 2 to align with base 1 and align the side rails 23 with v-groove rollers 6. Adapter 8 transitions the platform from vertical to horizontal movement over roller 7. The roller 7 position relative to v-groove rollers 6 and platform adapter 8 positions rails 23 to engage directly with v-groove rollers 6. During this initial loading phase, platform 2 is pivoting on wheels 13 on the ground as it is drawn up towards roller 7 by winch cable 25 attached to pin 24 through adapter 8. Referring to FIG. 2, wheels 13 are extended through telescoping square tubing and secured by removable pin 21 to limit the maximum angle that platform 2 reaches during loading to 45 degrees.

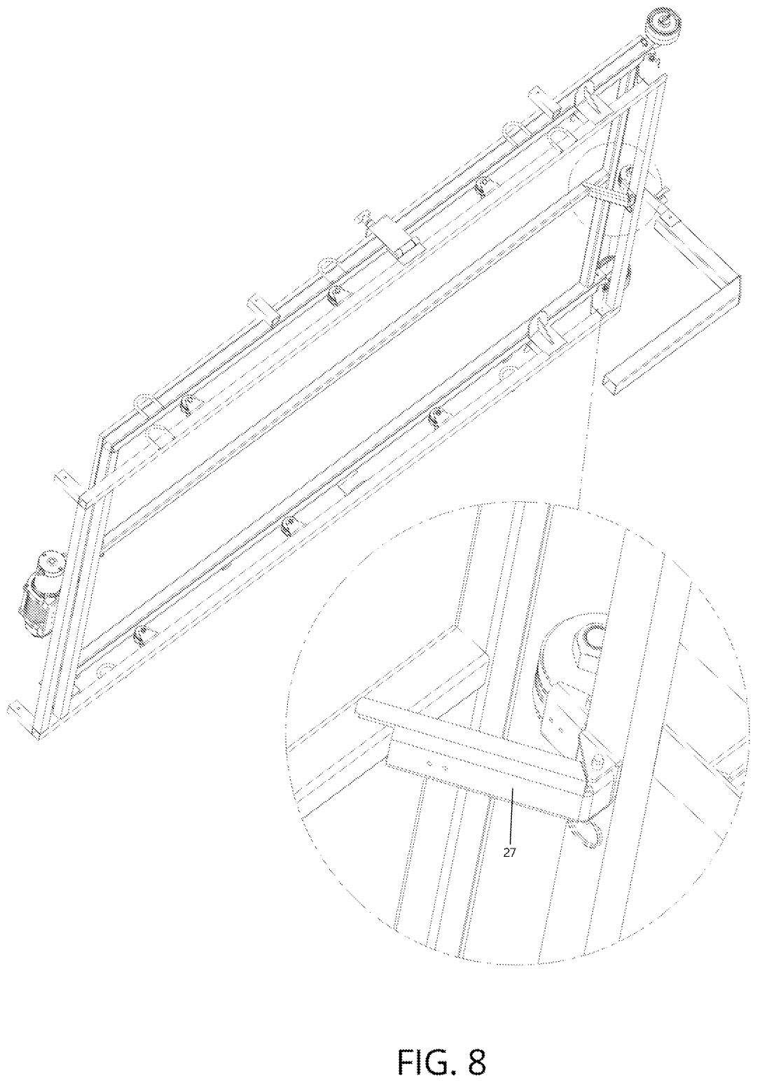

As the platform 2 is drawn in towards base 1, rails 23 roll over rollers 6 and a maximum load angle is reached. As the center of gravity of platform 2 crosses rollers 6 towards winch 3, the platform 2 will begin to lower from the maximum load angle. As platform 2 load angle reduces, rails 23 make contact with alignment plates 14 that guide rails 23 to engage with rollers 5 along the base 1. Referring to FIG. 8, alignment arm 27 centers the platform 2 during loading to align rails 23 with rollers 5.

As platform 2 is fully loaded onto base 1, platform 2 engages with the horizontal safety latch 9 and the limit switch on the horizontal safety latch 9 that automatically stops the winch 3. Horizontal safety latch 9 is spring loaded and latches onto pin 10 on platform 2. Horizontal safety latch 9 prevents horizontal movement of the platform 2 on the longitudinal axis. The 90 degree angle track 23 and v-groove rollers 5 engage to prevent horizontal movement of the platform 2 on the lateral axis. Vertical safety latch 11 engages with vertical safety latch receiver 12 on platform 2 to prevent vertical movement of the platform 2.

Tie-down rings 19 on platform 2 enable loads to be tied down to platform 2. Side stake mounts 18 enable side stakes and walls to be added to platform 2 to contain loose material and fragmented cargo. Tie down rings 20 on base 1 connect the base 1 to utility vehicle 4 with tie-downs.

What is claimed is:

1. A winch activated loading platform for cargo carrying vehicles and trailers, comprising:
A base frame installed in the cargo carrying area of the vehicle or trailer;
A platform that is loaded from the ground onto the base frame;
A singular winch attached to the base frame that loads the platform onto the base frame.

2. The apparatus of claim 1, wherein the platform assembly is centered and aligned to the base during loading with a singular winch by the means of laterally interfacing sheet metal parts.

3. The apparatus of claim 1, wherein the platform assembly transitions smoothly from vertical to horizontal movement with a singular winch by the means of rollers and sheaves.

4. The apparatus of claim 1, wherein the winch cable end is protected by internally pinning the cable to the steel tube frame of the platform.

5. The apparatus of claim 1, wherein the function of a pickup truck tailgate is preserved by means of a removable section of telescoping steel tube that can be stowed through means of telescoping steel tube.

6. The apparatus of claim 1, wherein the weight on a pickup truck tailgate is supported by a trailer hitch receiver by means of steel tube.
